(19) United States
(12) Patent Application Publication
(10) Pub. No.: US 2005/0118308 A1
(43) Pub. Date: Jun. 2, 2005

(54) Personal, mixed salad container

(76) Inventor: Robin B. Michnick, New York City, NY (US)

Correspondence Address: Charles I. Brodsky, Esq., 2 Bucks Lane, Marlboro, NJ, 07746, US

(21) Appl. No.: 10/722,960

(22) Filed: Nov. 28, 2003

(51) Int. Cl. A23B 4/00

(52) U.S. Cl. 426/112

(57) ABSTRACT

A plastic bag of predetermined dimension including first and second sealed compartments respectively containing preselected amounts of salad in one and salad dressing in the other, along with first means for dispensing the dressing into the salad and second means for opening the salad compartment after shaking the mixture together.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to lunchtime or take-along eating, in general, and to a personal, mixed salad container usable therefor, in particular.

2. Description of the Related Art

As is well known and understood, more-and-more of today's population are becoming increasingly conscious of the need for healthful eating; to such end, a greater emphasis is being placed on the advantages which follow from consuming salads, either as part of one's meal, or as the entire meal itself. While making dressed salads at home is a relatively easy task to do, and ordering salads when dining out is an everyday occurrence, problems arise in attempting to have a salad during lunch at one's office, or when just eating outdoors. In those instances, it becomes inconvenient to have to carry a bottle, or other similar container, of salad dressing along with the salad itself, to be mixed together at the time the salad is to be consumed. Adding the dressing beforehand—as when leaving for work, for example—results in the salad becoming soggy over time, as it sits in its bag absorbing all the while the dressing that is added. In fact, the longer a lettuce ingredient stays within its bag absorbing the dressing for instance, the more the lettuce becomes limp and loses its taste, with the end result being that when chewing it, essentially all that one gets is the flavoring of the dressing alone, without the lettuce. As increasing numbers of people accept the benefits which follow from eating these types of salads at their desk or while sunning themselves during the noontime lunch hour, the more it would be desirable to have a simpler means of transporting the salad and its dressing about, and to have them separate before their mixing, to be then mixed together when they are ready to be consumed.

### SUMMARY OF THE INVENTION

As will become clear from the following description, a personal mixed salad container which allows this according to the invention includes a plastic bag of predetermined dimension, a first sealed compartment within the bag containing a preselected amount of salad, and a second compartment within the bag containing a preselected lesser amount of salad dressing. First means are provided for dispensing the salad dressing from this second compartment into this first compartment while the first compartment containing the salad remains sealed, and second means are included for then opening the first compartment after shaking the mixture of the salad and salad dressing together. A tossed salad then results which can be eaten right from the bag, or which can then be emptied onto a plate. While a preferred composition for this carryable, take-along container might comprise polyethylene teraphalite (PET), by making the bag of a stiffer plastic, a self-serving bowl could result with the seams of the bag then standing on their own.

For the preferred embodiment of the invention employing a soft plastic bag for personal carry-along use, the ratio of salad to salad dressing within the first and second sealed compartments of the container may be of the order of 3-5:1 by weight. In such an embodiment, the first sealed compartment may container substantially 1-2 cups of salad, while the second sealed compartment may contain substantially 1-2 tablespoons of salad dressing. For personal lunchtime use, in making the tossed salad which results as a main meal, the first sealed compartment may then contain substantially 8-16 ounces of salad, while the second sealed compartment may contain substantially 3-6 ounces of salad dressing. As will be appreciated, because the oil or vinegar of the dressing then coats the insides of the bag as the bag is shaken in tossing the two together, the mixed salad container of the invention is not generally intended to be reusable, due to the difficulty in trying to wash out the bag's insides.

As will be seen below, different constructions for this personal, mixed salad container can be had; in one, the recited first means can dispense the salad dressing upwardly from the second sealed compartment into the first sealed compartment holding the salad; alternatively, the first means can dispense the salad dressing downwardly into that first sealed compartment—or can mix the two together from a sideways dispensing. Opening the first compartment for eating the then mixed salad and salad dressing can then be by way of opening a press-to-seal adhesive, a slide lock, a zipper lock or any other temporary interlocking coupling established between opposing top sides of the plastic bag in readily understandable manner. Dispensing the salad dressing into the salad itself can be by way of a rupturable separation established between the two compartments, with the admixture following the application of finger pressure to break the separation.

In any of these aforesaid constructions—and whether the bag be fabricated of a soft or hard plastic composition—, the end result will be seen to be the separation of these two ingredients within the bag until such time one is ready to eat his/her salad meal, with the mixing and tossing of the ingredients then being readily obtainable simply by breaking their separation, shaking the ingredients together, and then opening the first compartment to gain entry to the dressed salad then within the container, ready to be eaten.

### BRIEF DESCRIPTION OF THE DRAWINGS

These and other features of the present invention will be more clearly understood from a consideration of the following description, taken in connection with the accompanying Drawings, in which:

FIGS. 1-3 illustrates three separate manners of constructing the personal, mixed salad container of the invention in accordance with these stated principles.

### DETAILED DESCRIPTION OF THE INVENTION

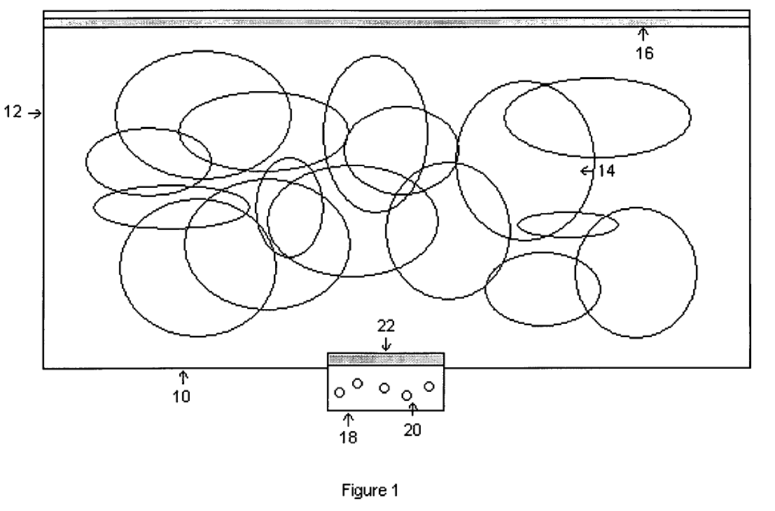

In FIGS. 1-3, the mixed salad container 10, of plastic composition of predetermined dimension, includes a first compartment 12 containing a predetermined amount of salad 14. With the container preferably composed of a polyethylene teraphalite (PET) plastic or other plastic bag, the compartment 12 may be temporarily sealed by any adhesive or other interlocking coupling at its top, as shown by the reference numeral 16. As will be appreciated, such closure generally may be had between opposing top sides of the plastic bag. A second compartment 18, on the other hand, contains a preselected lesser amount of salad dressing, 20. In accordance with the invention, the dressing 20 is kept apart from the salad 14 by a rupturable membrane or like separation between the compartments 12, 18, indicated at 22.

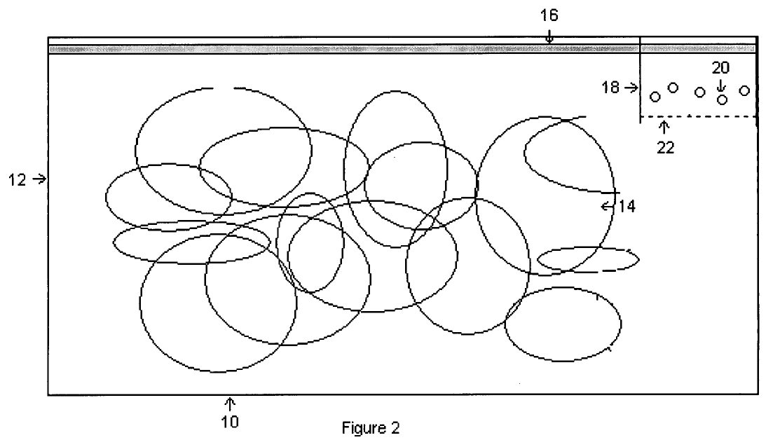

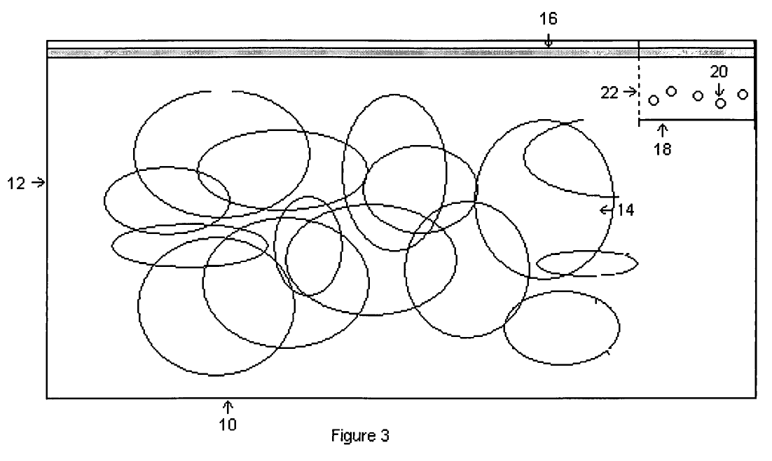

As shown in FIG. 1, the second compartment 18 is generally located at a lower point than the compartment 12 (as extending below it, for example), so that rupturing the separation 22 (as by finger pressure) dispenses the salad dressing upwardly into the salad compartment 12. In FIG. 2, on the other hand, the position of the second compartment 18 is located generally above the salad 14, so that rupturing the separation 22 dispenses the salad dressing 20 downwardly into the salad compartment 12; FIG. 3, similarly, shows the dressing compartment 18 off to the side of the salad 14 so that rupturing its separation 22 dispenses the dressing 20 sideways into the salad 14. Such separation 22 in each of the embodiments of FIGS. 1-3 may also be constructed of its own adhesive or interlocking fastenings, to be thereafter opened between its own opposing top sides (FIG. 1), bottom sides (FIG. 2) or adjacent sides (FIG. 3) in dispensing the dressing 20 into the salad compartment 12. With compartment 12 then continuing to be sealed, the plastic bag can simply be spun about or otherwise shaken to toss the salad with the salad dressing in mixing the ingredients together as desired. The first compartment 12 can then be opened by separating its top edges along the coupling 16 to permit access into the container 10 by way of spoon, fork or knife, for example, or alternatively, its contents could be simply shaken out onto one's plate for eating.

In an actual construction of the mixed salad container of the invention, a ratio of salad to salad dressing within the compartments 12 and 18 of the order of 3-5:1 by weight has been determined to be highly desirable in obtaining a thorough mixture of the dressing with the salad. This follows with the sealed compartment 12 containing substantially 1-2 cups of salad to begin with, and with the second compartment 18 containing substantially 1-2 tablespoons of salad dressing. A meal of this dressed salad could then follow with the first sealed compartment 12 containing substantially 8-16 ounces of salad, and with the second sealed compartment 18 containing substantially 3-6 ounces of dressing. Rather than having a separate salad carried along for lunch or for outdoor's eating, and then drizzling dressing atop it from a separate bottle or like container, the personal, mixed salad container of the invention allows a preselection of the amounts of salad to be stored in one compartment, separate from a preselected amount and type of salad dressing in a second compartment, keeping them separate until a time of desired eating, so that the salad ingredients remain fresh, crisp and tasty when eaten.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the scope of the invention.

1. A personal, mixed salad container comprising:
a plastic bag of predetermined dimension;
a first sealed compartment within said bag containing a preselected amount of salad;
a second compartment within said bag containing a preselected lesser amount of salad dressing;
first means for dispensing said salad dressing from said second compartment into said first compartment while said first compartment remains sealed; and
second means for opening said first compartment after shaking the mixture therein of said salad and salad dressing.

2. The personal mixed salad container of claim 1 wherein said plastic bag is of a PET composition.

3. The personal mixed salad container of claim 1 wherein the ratio of salad to salad dressing within the first and second sealed compartments is of the order of 3-5:1 by weight.

4. The personal mixed salad container of claim 1 wherein said first sealed compartment contains substantially 1-2 cups of salad.

5. The personal mixed salad container of claim 1 wherein said second sealed compartment contains substantially 1-2 tablespoons of salad dressing.

6. The personal mixed salad container of claim 1 wherein said first sealed compartment contains substantially 8-16 oz. of salad and said second sealed compartment contains substantially 3-6 oz. of salad dressing.

7. The personal mixed salad container of claim 1 wherein said first means dispenses said salad dressing upwardly into said first sealed compartment.

8. The personal mixed salad container of claim 1 wherein said first means dispenses said salad dressing downwardly into said first sealed compartment.

9. The personal mixed salad container of claim 1 wherein said second means includes one of an adhesive and interlocking coupling between opposing top sides of said plastic bag.

10. The personal mixed salad container of claim 9 wherein said first means includes one of an adhesive and interlocking coupling between opposing top sides of said second sealed compartment extending in one of an upward and downward direction into said first sealed compartment.

11. The personal mixed salad container of claim 1 wherein said first means includes a rupturable separation between said first and second compartments rupturable by applied finger pressure.
